(19) United States
(12) Patent Application Publication
(10) Pub. No.: US 2009/0287793 A1
(43) Pub. Date: Nov. 19, 2009

(54) MARKUP ELEMENTS IN REFERENCED CONTENT

(76) Inventors: Patrick Joseph O'Sullivan, Ballsbridge (IE); Robert Cameron Weir, Westford, MA (US); Edith Helen Stern, Yorktown Heights, NY (US); Barry E. Willner, Briarcliff Manor, NY (US)

Correspondence Address: HOLLAND & KNIGHT, 10 ST. JAMES AVENUE, BOSTON, MA, 02116-3889, US

(21) Appl. No.: 12/122,960

(22) Filed: May 19, 2008

(51) Int. Cl. G06F 15/16

(52) U.S. Cl. 709/218

(57) ABSTRACT

A method and computer program product for associating one or more markup elements with one or more portions of a piece of content and associating a reference to the piece of content with communication. The reference to the piece of content includes an indicator of the one or more markup elements associated with the one or more portions of the piece of content. The communication is sent to at least one recipient. The reference to the piece of content enables the piece of content, including the one or more markup elements, to be accessed by the recipient.

### TECHNICAL FIELD

This disclosure generally relates to sharing content, and more particularly relates to markup elements in referenced content in communications

### BACKGROUND

Today, use email is used as a general tool for broad collaboration. However, the mechanisms available to send, receive and process email and content therein have limitations. Co-dependent technologies often represent an obstacle to effective collaboration. Specifically, the association of a URLs or links to document libraries, team rooms, content in databases, or Web Site references in an email is a very powerful capability. An email recipient can select the link in the email that in turn brings the recipient to a place that stores the information referenced by the link. This capability keep emails short and concise, and eliminates duplication and unnecessary propagation of content. However, circumstances oftentimes arise where the originator of an email may deem subsets of the content in the referenced material, such as a particular paragraph in a voluminous web page, as relevant. Unfortunately conventional email systems merely provide the recipient with convenient access to the content, and force the recipient to figure out for themselves what is relevant. For example, upon receiving an email with a link to a document in a document library, and accessing the document referenced by the link, the recipient may have to continuously alternate between email and the document library to read the content that the sender wanted them to read.

### SUMMARY OF THE DISCLOSURE

According to a first implementation, a method includes associating one or more markup elements with one or more portions of a piece of content. A reference to the piece of content is associated with a communication. The reference to the piece of content includes an indicator of the one or more markup elements associated with the one or more portions of the piece of content. The communication is sent to at least one recipient. The reference to the piece of content enables the piece of content, including the one or more markup elements, to be accessed by the recipient.

One or more of the following features may be included. The one or more markup elements may include a designation of the one or more portions of the piece of content. The one or more markup elements may include an annotation associated with the one or more portions of the piece of content. The piece of content may include a webpage. The piece of content may include a document in a document library. The piece of content may include an item in a team space. The piece of content includes a discussion topic on an internet forum.

Associating the reference to the piece of content with a communication may include embedding a link to the piece of content in the communication. The reference to the piece of content, including an indicator of the one or more markup elements, may include a designator of the one or more portions of the piece of content. The designator of the one or more portions of the piece of content may include one or more beginning and end delimiters.

According to another implementation, a computer program product includes a computer readable medium having a plurality of instructions stored on it. When executed by a processor, the instructions cause the processor to perform operations including associating one or more markup elements with one or more portions of a piece of content. A reference to the piece of content may be associated with a communication. The reference to the piece of content includes an indicator of the one or more markup elements associated with the one or more portions of the piece of content. The communication is sent to at least one recipient. The reference to the piece of content enables the piece of content, including the one or more markup elements, to be accessed by the recipient.

One or more of the following features may be included. The one or more markup elements may include a designation of the one or more portions of the piece of content. The one or more markup elements may include an annotation associated with the one or more portions of the piece of content. The piece of content may include a webpage. The piece of content may include a document in a document library. The piece of content may include an item in a team space. The piece of content may include a discussion topic on an internet forum.

The instructions for associating the reference to the piece of content with a communication may include instructions for embedding a link to the piece of content in the communication. The reference to the piece of content, including an indicator of the one or more markup elements, may include a designator of the one or more portions of the piece of content. The designator of the one or more portions of the piece of content may include one or more beginning and end delimiters

The details of one or more implementations are set forth in the accompanying drawings and the description below. Other features and advantages will become apparent from the description, the drawings, and the claims.

### BRIEF DESCRIPTION OF THE DRAWINGS

FIG. 1 diagrammatically depicts a markup process, a viewer application and communication application coupled to a distributed computing network.

FIG. 2 is a flowchart of a process performed by the markup process of FIG. 1.

FIG. 3 diagrammatically depicts a display screen rendered by the viewer application of FIG. 1.

FIG. 4 diagrammatically depicts an email user interface rendered by the communication application of FIG. 1.

FIG. 5 diagrammatically depicts an email rendered by the communication application of FIG. 1.

FIG. 6 diagrammatically depicts a display screen rendered by the viewer application of FIG. 1.

FIG. 7 diagrammatically depicts a display screen rendered by the viewer application of FIG. 1.

### DETAILED DESCRIPTION OF PREFERRED EMBODIMENTS

System Overview

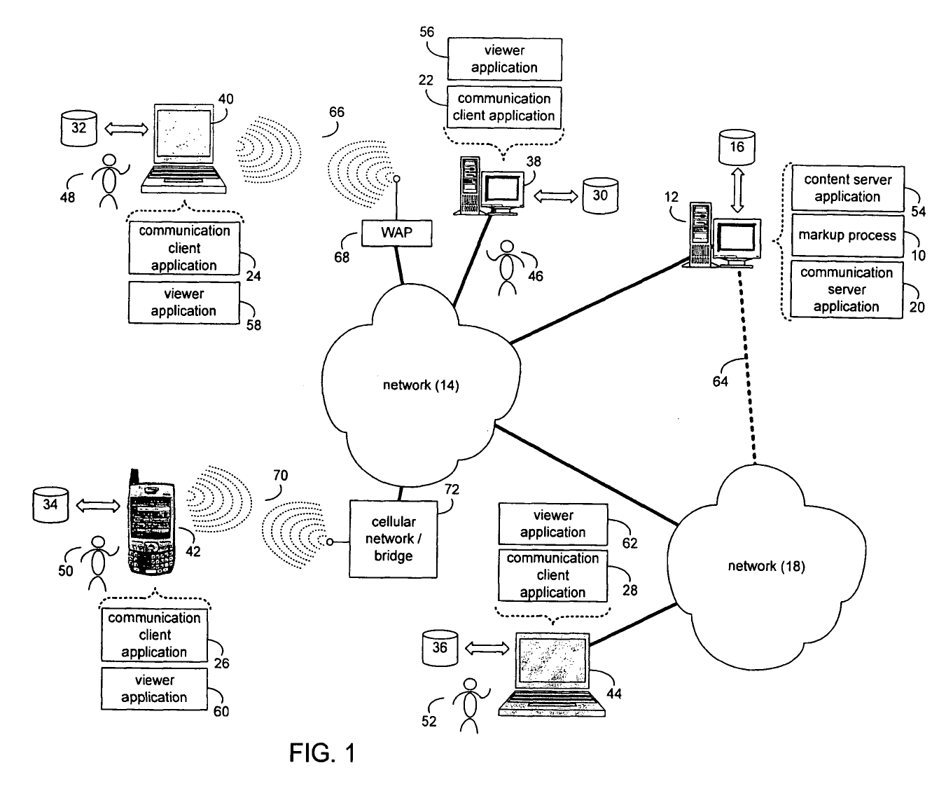

Referring to FIG. 1, there is shown markup process 10 that may reside on and may be executed by server computer 12, which may be connected to network 14 (e.g., the Internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft Windows XP Server™; Novell Netware™; or Redhat Linux™, for example. Additionally/alternatively, while not shown, the markup process may reside on and be executed, in whole or in part, by one or more client electronic devices, such as a personal computer, notebook computer, personal digital assistant, or the like.

As will be discussed below in greater detail, markup process 10 may associate one or more markup elements with one or more portions of a piece of content. A reference to the piece of content may be associated with communication. The reference to the piece of content may include an indicator of the one or more markup elements associated with the one or more portions of the piece of content. The communication may be sent to at least one recipient. The reference to the piece of content may enable the piece of content, including the one or more markup elements, to be accessed by the recipient.

The instruction sets and subroutines of markup process 10, which may be stored on storage device 16 coupled to server computer 12, may be executed by one or more processors (not shown) and one or more memory architectures (not shown) incorporated into server computer 12. Storage device 16 may include but is not limited to: a hard disk drive; a solid state drive; a tape drive; an optical drive; a RAID array; a random access memory (RAM); and a read-only memory (ROM).

Server computer 12 may execute a web server application, examples of which may include but are not limited to: Microsoft IIS™, Novell Webserver™, or Apache Webserver™, that allows for HTTP (i.e., HyperText Transfer Protocol) access to server computer 12 via network 14. Network 14 may be connected to one or more secondary networks (e.g., network 18), examples of which may include but are not limited to: a local area network; a wide area network; or an intranet, for example.

Server computer 12 may execute communication server application 20, examples of which may include, but are not limited to an email server application (e.g., IBM Domino™ Server, and Microsoft Exchange™ Server), and instant messaging server application (e.g., IBM Lotus Sametime™, Microsoft Office Live Communications Server™, Jabber XCP™, and AOL Instant Messenger™), for example, or other communication application which allows the inclusion of referenced content. Communication server application 20 may store and route communications to one or more communication client applications, e.g., communication client applications 22, 24, 26, 28, examples of which may include but are not limited to email client applications (e.g., IBM Lotus Notes™, and Microsoft Outlook™), instant messaging client applications (e.g., IBM Lotus Sametime™, Microsoft Office Communicator™, Google Talk™, and AOL Instant Messenger™), for example, or other communication client applications which allow for the inclusion of referenced content. Markup process 10 may be a stand-alone application that interfaces with communication server application 20 or an applet/application that is executed within communication server application 20.

The instruction sets and subroutines of communication server application 20, which may be stored on storage device 16 coupled to server computer 12, may be executed by one or more processors (not shown) and one or more memory architectures (not shown) incorporated into server computer 12.

The instruction sets and subroutines of communication client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; solid state drives; tape drives; optical drives; RAID arrays; random access memories (RAM); read-only memories (ROM), compact flash (CF) storage devices, secure digital (SD) storage devices, and a memory stick storage devices. Examples of client electronic devices 38, 40, 42, 44 may include, but are not limited to, personal computer 38, laptop computer 40, personal digital assistant 42. notebook computer 44, a data-enabled, cellular telephone (not shown), and a dedicated network device (not shown), for example. Using communication client applications 22, 24, 26, 28, users 46, 48, 50, 52 may access communication server application 20 and may receive, create, and manage communications.

As mentioned above, in addition/as an alternative to being a server-side application residing on server computer 12, the markup process may be a client-side application (not shown) residing on one or more client electronic devices (e.g., personal computer 38; or client electronic devices 40, 42, 44; not shown). In a client-side implementation, the markup process may be a stand alone application that interfaces with a communication client application (e.g., communication client applications 22, 24, 26, 28), or may be an applet/application that is executed within a communication client application. As such, the markup process may be a client-side process, a server-side process, or a hybrid client-side/server-side process (e.g., the combination of server-side markup process 10 and one or more client-side markup processes), which may be executed, in whole or in part, by server computer 12, and/or one or more of client electronic device (e.g., client electronic devices 38, 40, 42, 44).

In addition to communication server application 20, server computer 12 may execute one or more content server applications (e.g., content server application 54). Examples of content server application 54 may include, but is not limited to, a document management application, a document library application, a team space, or other collaborative content access and/or management applications. The instruction sets and subroutines of content server application 54, which may be stored on storage device 16, may be executed by one or more processors (not shown) and memory architectures (not shown) incorporated into server computer 12. Additionally, any content (e.g., documents, collaborative content, or the like) accessible via, and/or managed by, content server application 54, may be stored on storage device 16.

One or more of client electronic devices 38, 40, 42, 44 may each execute a content view application (e.g., viewer applications 56, 58, 60, 62). Examples of content viewer applications may include, but are not limited to, web browsers, word processing applications, PDF viewers, and applications for accessing content via content server application 54, for example. Using viewer applications 56, 58, 60, 62, users 46, 48, 50, 52 may access content stored on server computer 12 (e.g., via content server application 54), and/or stored on other content systems (e.g., third party content systems, such as web servers hosting one or more websites, document libraries, and the like). The instruction sets and subroutines of viewer applications 56, 58, 60, 62, which may be stored on storage devices 30, 32, 34, 36, respectively, may be executed by one or more processors (not shown) and one or more memory architectures (not shown) incorporated into client electronic devices 38, 40, 42, 44, respectively. Further, viewer applications 56, 58, 60, 62 may interact with markup process 10 and/or a client-side markup process (not shown) executed by respective client electronic devices 38, 40, 42, 44.

Users 46, 48, 50, 52 may access communication server application 20, content server application 54, and remote content directly through client electronic devices 38, 40, 42, 44 upon which communication client applications 22, 24, 26, 28 and viewer applications 56, 58, 60, 62 are executed. Users 46, 48, 50, 52 may access communication server application 20, content server application 54, as well as third party content systems, directly through network 14 or through secondary network 18. Further, server computer 12 (i.e., the computer that executes communication server application 20 and content server application 54) may be connected to network 14 through secondary network 18, as illustrated with phantom link line 64.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 66 established between laptop computer 40 and wireless access point (i.e., WAP) 68, which is shown directly coupled to network 14. WAP 68 may be, for example, an IEEE 802.11a, 802.11b, 802.11g, Wi-Fi, and/or Bluetooth device that is capable of establishing wireless communication channel 66 between laptop computer 40 and WAP 68. Personal digital assistant 42 is shown wirelessly coupled to network 14 via wireless communication channel 70 established between personal digital assistant 42 and cellular network/bridge 72, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Client electronic devices 38, 40, 42, 44 may each execute an operating system, examples of which may include but are not limited to Microsoft Windows™, Microsoft Windows CE™, Redhat Linux™, or a custom operating system.

### Markup Process

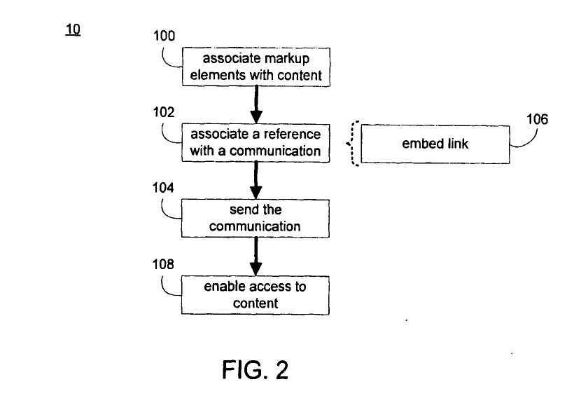

Referring also to FIG. 2, markup process 10 may associate 100 one or more markup elements with one or more portions of a piece of content. Markup process 10 may further associate 102 a reference to the piece of content with a communication. The reference to the piece of content may include an indicator of the one or more markup elements associated with the one or more portions of the piece of content. The communication may be sent 104 to at least one recipient. The reference to the piece of content may enable the piece of content, which may include the one or more markup elements, to be accessed by the recipient.

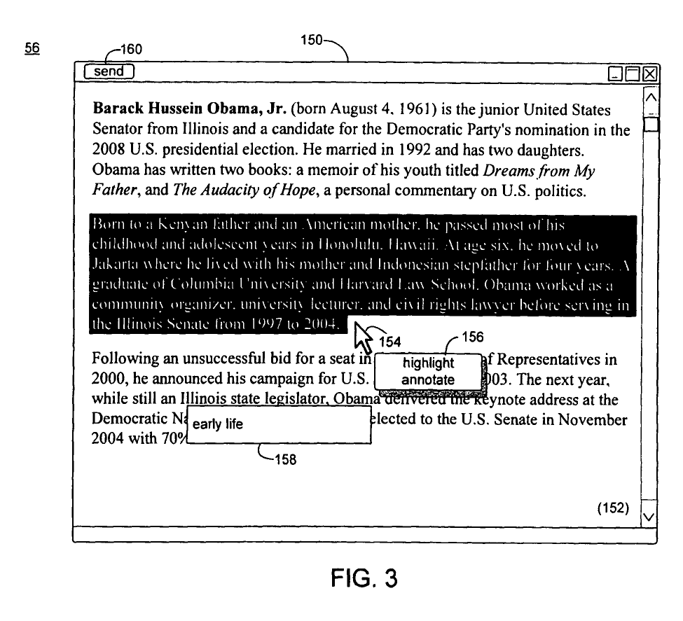

For example, and referring also to FIG. 3, a user (e.g., user 46) may access a piece of content using viewer application 56. Viewer application 56 (alone or in conjunction with one or more additional applications) may render display screen 150 including content 152. The piece of content may include, for example, a webpage, such as a wiki, a blog, discussion forum, or other webpage; a piece of content included in a teamspace (e.g., which may be managed by content server application 54); a document from a document library (e.g., which may be managed by content server application 54); or other piece of content. Various other types of content may similarly be viewed using viewer application 56, and the foregoing examples should not be construed as a limitation of the present disclosure. Additionally, the piece of content may include local content (e.g., residing on client electronic device 38, for example).

As is generally known, a wiki is a website that may allow visitors to add, remove, and edit content. As a collaborative technology for organizing information on websites, wikis may allow for linking amongst any number of webpages. Wikis may be editable by the general public.

A blog is a website in which entries may be written in a chronological order and may be displayed in reverse chronological order. Blogs may provide commentary or news on a particular subject, such as food, politics, or local news; or may function as a personal online diary.

A teamspace is a web-based collaborative workspace for managing shared work processes and maintaining shared artifacts in a project that may span months or years. A teamspace may cover both synchronous and asynchronous cross-company team activities and may provide a seamless transition between different work modes.

As mentioned above, markup process 10 may associate 100 one or more markup elements with one or more portions of a piece of content. The one or more markup elements may include a designation of the one or more portions of the piece of content. With continued reference to FIG. 3, user 46 may select at least a portion of content 152. For example, user 46 may select a portion of content 152 using onscreen pointer 154 (e.g., which may be controlled by a pointing device, such as a mouse; not shown), e.g., by left-clicking and dragging onscreen pointer 154 over the desired portion of content 152. User 46 may further “right-click” the pointing device, resulting in viewer application 56 and/or markup process 10 rendering popup 156. While popup 156 is shown only including two options (namely “highlight” and “annotate”), this is intended for exemplary purposes only, as the number and nature of options included within popup 156 may vary according to user need and design criteria.

User 46 may select, via onscreen pointer 154, the option “highlight” from within popup 156. Selecting the option “highlight” may result in markup process (alone or in conjunction with viewer application 56) designating the selected portion of content 152. Markup process (alone or in conjunction with viewer application 56) may associate 100 the designation (e.g., highlighting) with the selected portion of content 152. While only one portion of content 152 is shown as being highlighted, this is not intended to be a limitation of the present disclosure. For example, user 46 may highlight multiple portions of content 152 in the manner as described above.

The one or more markup elements may include an annotation associated with the one or more portions of the piece of content. Continuing with the above-stated example, user 46 may position onscreen pointer 154 adjacent to a portion of content 152 that user 46 wishes to annotate (e.g., which may be the same as, or different than, the highlighted portion of content 152). As described above, user 46 may right-click the pointing device. Right-clicking the pointing device may result in markup process 10 (alone or in conjunction with viewer application 56) rendering popup 156, including the options “highlight” and “annotate”. Selecting the option “annotate” from within popup 156 may result in markup process 10 (alone or in conjunction with viewer application 56) rendering annotation input box 158. User 46 may input (e.g., using a keyboard coupled to personal computer 38; not shown) a desired annotation. Markup process 10 (alone or in conjunction with viewer application 56) may associate the 100 the annotation with the selected portion of content. As with designating one or more portions of content 152, user 46 may associate multiple annotations with various portions of content 152, e.g., by repeating the annotation process described above for each desired annotation and portion of content 152.

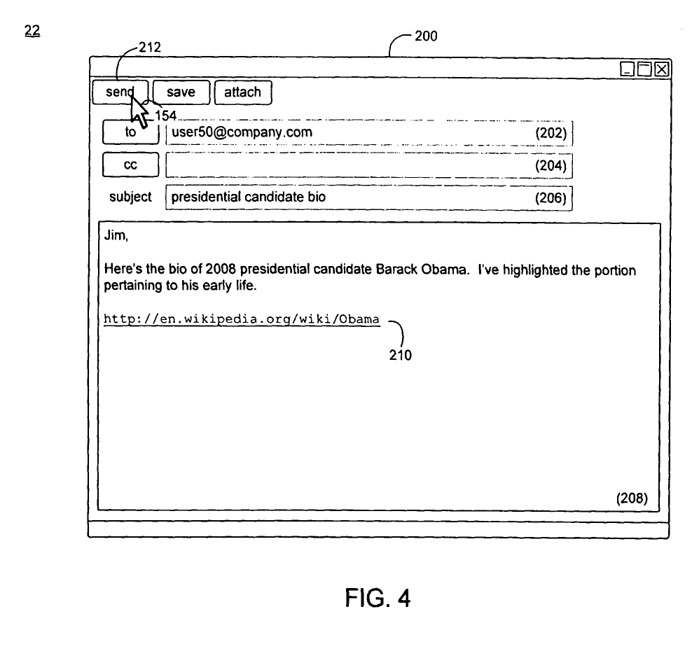

Markup process 10 may associate 102 a reference to the piece of content with a communication. For the purpose of the following description, the communication will be described as an email. However, this should not be construed as a limitation, as other forms of communication (e.g., instant messaging, and the like), which may include a reference to the piece of content, may equally be utilized. The reference to the piece of content may include an indicator of the one or more markup elements associated with the one or more portions of the piece of content. Continuing with the above-stated example, user 46 may select, using onscreen pointer 154, “send” button 160. Referring also to FIG. 4, selecting “send” button 160 may result in markup process (alone or in conjunction with one or more of communication client application 22 and viewer application 56) rendering email user interface 200 (e.g., in the illustrative example, in which communication client application 22 may include an email client application).

Email user interface 200 may allow user 46 to address the email message to one or more “to” recipients 202, and one or more “cc” recipients 204 (e.g., by inputting recipient email addresses via a keyboard, by selecting recipients from an email contacts list, or the like). Additionally, email user interface 200 may allow user 46 to specify a subject of the email (e.g., “presidential candidate bio”). Additionally, user 46 may provide email content 208 (e.g., the body of the email message). Markup process 10 (alone or in conjunction with communication application 22) may associate 102 a reference to the piece of content (e.g., content 152) with the email message. For example, as shown, associating 102 a reference to the piece of content may include embedding 106 link 210 to the piece of content in the email message. Various additional/alternative implementations may also be utilized for associating 102 the reference to the piece of content with the email, such as including a copy of the piece of content as an attachment to the email, etc.

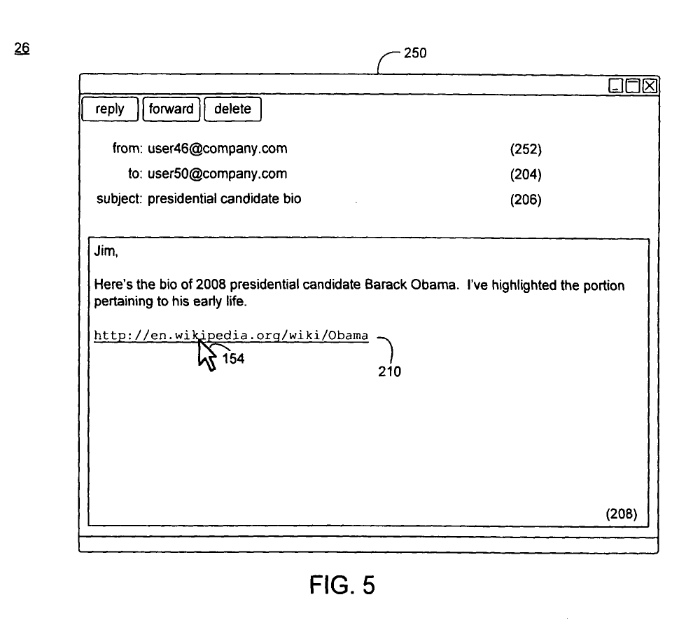

Markup process 10 (alone or in conjunction with communication client application 22 and/or communication server application 20) may send 104 the email to specified “to” recipients 202 and “cc” recipients 204. For example, once user 46 has provided desired email content 208, user 46 may select, via onscreen pointer 154 “to” button 212. Referring also to FIG. 5, via communication client application 26, specified “to” recipient 202 (i.e., user 50) may receive email message 250. Email message 250 may include content 208 and link 210 to the piece of content. Markup process 10 (alone or in conjunction with viewer application 60) may enable 108 the piece of content including the one or more markup elements to be accessed by the recipient, e.g., by allowing user 50 to select link 210 using onscreen pointer 154.

Continuing with the above-stated example, selecting, via onscreen pointer 154, link 210 in email message 250 may result in markup process (alone or in combination with one or more applications, such as viewer application 60) rendering content 152 referenced by link 210. Content 152 may be accessed from the source referenced by the link. For example, if content 152 is a webpage, selecting link 210 may result in a web browser (e.g., viewer application 60) being launched and directed to the URL (uniform resource locator) of the webpage. Similar launching of an appropriate viewer and access of content 152 may take place for various different types of content (e.g., documents in a document library, etc.). Any access restrictions to content 152 may be managed in a conventional manner, e.g., by requiring user 50 to input an appropriate username and password, etc.

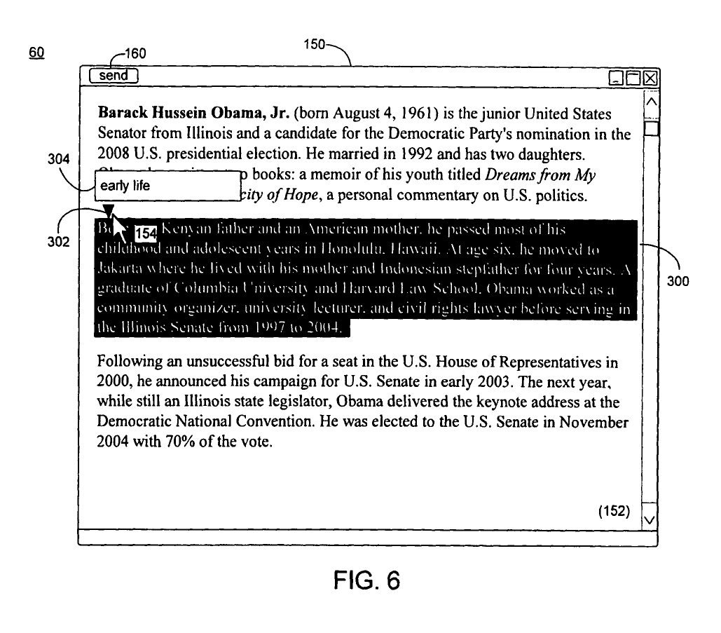

Referring also to FIG. 6, viewer application 60 may render display screen 150 including content 152. Additionally, markup process 10 (alone or in conjunction with viewer application 60) may render one or more markup elements associated 100 with content 152 by user 46. For example, email message 250 may include meta data that provides the necessary logic to apply the one or more markup elements to content 152 rendered by viewer application 60. In addition/as an alternative to meta data included in email message 250, a workflow may be associated with an email client application (e.g., communication client application 26) and/or an email server application (e.g., communication server application 20), e.g., via extension points provided for in the RFC's (requests for comment) associated with email routing protocols (e.g., SMTP, i.e., “simple mail transfer protocol”). A workflow associated with an email application via extension points provided for in the RFC's may allow one or more of the markup elements to be exposed for the user of cooperating host (e.g., communication client application 22) and destination (e.g., communication client application 26) email systems.

Continuing with the above-stated example, email 250 may, for example, include meta data indicating begin and end delimiters of the designator of the one or more pieces of content 152. Based upon the begin and end delimiters, as well as meta data indicating highlighting of the delimited portion of content 152, markup process 10 (alone or in conjunction with viewer application 60) may provide highlighting 300 associated with a portion of content 152 designated by user 46. Similarly, markup process 10 (alone or in conjunction with viewer application 60) may provide indicator 302 of an annotation markup element. User 50 may select, via onscreen pointer 154, indicator 302. Upon selecting indicator 302, markup process 10 (alone or in conjunction with viewer application 60) may render popup 304. Popup 304 may include the annotation input by user 46 (namely “early life”).

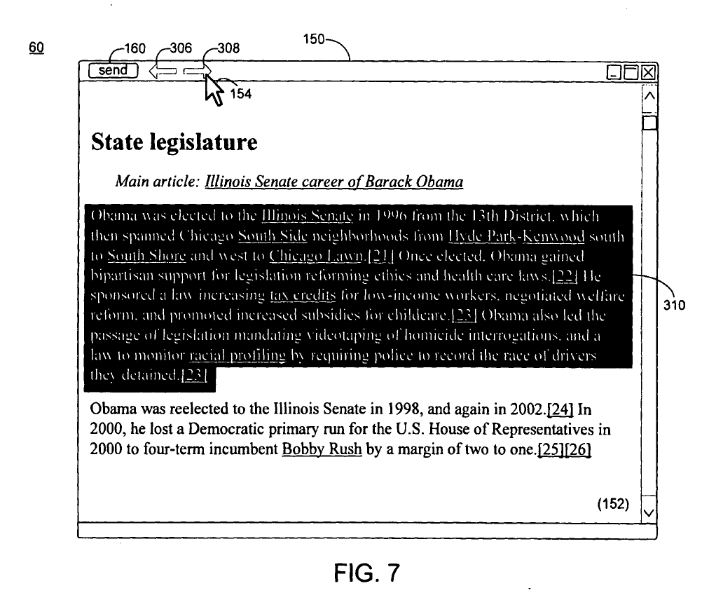

As discussed above, markup process 10 may allow a user (e.g., user 46) to associate 100 a plurality of markup elements (e.g., highlighted portions, annotations, and the like) with various portions of content 152. All such markup elements may be exposed to a user (e.g., user 50) receiving a communication (e.g., email 250) including the reference to content 152. In addition to exposing all of the markup elements associated 100 with content 152, markup process 10 (alone or in conjunction with viewer application 60) may allow user 50 to conveniently move between markup elements. For example, and referring also to FIG. 7, markup process 10 and/or viewer application 60, may provide a feature (e.g., previous button 306 and/or next button 308) allowing user 50 to move between a plurality of markup elements associated 100 with content 152. For example, user 50 may move to a subsequent markup element (e.g., highlighted portion, annotation, and the like) by selecting, via onscreen pointer 154, next button 308. Selecting next button 308 may result in markup process (alone or in conjunction with viewer application 60) displaying a subsequent portion of content 152 including subsequent a subsequent markup element (e.g., highlighting 310). User 50 may similarly move to additional subsequent markup elements (not shown) and related portions of content 152 and/or may move to previous markup elements (not shown) and related portions of content 152.

A number of implementations have been described. Nevertheless, it will be understood that various modifications may be made. Accordingly, other implementations are within the scope of the following claims.

What is claimed is:

1. A method comprising:
associating one or more markup elements with one or more portions of a piece of content;
associating a reference to the piece of content with a communication, the reference to the piece of content including an indicator of the one or more markup elements associated with the one or more portions of the piece of content;
sending the communication to at least one recipient, the reference to the piece of content enabling the piece of content, including the one or more markup elements, to be accessed by the recipient.

2. The method of claim 1, wherein the one or more markup elements includes a designation of the one or more portions of the piece of content.

3. The method of claim 1, wherein the one or more markup elements includes an annotation associated with the one or more portions of the piece of content.

4. The method of claim 1, wherein the piece of content includes a webpage.

5. The method of claim 1, wherein the piece of content includes a document in a document library.

6. The method of claim 1, wherein the piece of content includes an item in a teamspace.

7. The method of claim 1, wherein the piece of content includes a discussion topic on an internet forum.

8. The method of claim 1, wherein associating the reference to the piece of content with a communication includes embedding a link to the piece of content in the communication.

9. The method of claim 1, wherein the reference to the piece of content, including an indicator of the one or more markup elements, includes a designator of the one or more portions of the piece of content.

10. The method of claim 9, wherein the designator of the one or more portions of the piece of content include one or more beginning and end delimiters.

11. A computer program product comprising a computer readable medium having a plurality of instructions stored thereon, which, when executed by a processor, cause the processor to perform operations comprising:
associating one or more markup elements with one or more portions of a piece of content;
associating a reference to the piece of content with a communication, the reference to the piece of content including an indicator of the one or more markup elements associated with the one or more portions of the piece of content;
sending the communication to at least one recipient, the reference to the piece of content enabling the piece of content, including the one or more markup elements, to be accessed by the recipient.

12. The computer program product of claim 11, wherein the one or more markup elements includes a designation of the one or more portions of the piece of content.

13. The computer program product of claim 11, wherein the one or more markup elements includes an annotation associated with the one or more portions of the piece of content.

14. The computer program product of claim 11, wherein the piece of content includes a webpage.

15. The computer program product of claim 11, wherein the piece of content includes a document in a document library.

16. The computer program product of claim 11, wherein the piece of content includes an item in a teamspace.

17. The computer program product of claim 11, wherein the piece of content includes a discussion topic on an internet forum.

18. The computer program product of claim 11, wherein the instructions for associating the reference to the piece of content with a communication include instructions for embedding a link to the piece of content in the communication.

19. The computer program product of claim 11, wherein the reference to the piece of content, including an indicator of the one or more markup elements, includes a designator of the one or more portions of the piece of content.

20. The computer program product of claim 19, wherein the designator of the one or more portions of the piece of content include one or more beginning and end delimiters.
